(19) United States
(12) Patent Application Publication
(10) Pub. No.: US 2014/0037249 A1
(43) Pub. Date: Feb. 6, 2014

(54) OPTICAL FIBER CONNECTOR

(71) Applicants: HONG FU JIN PRECISION INDUSTRY (ShenZhen) CO.,LTD., (US); HON HAI PRECISION INDUSTRY CO., LTD., New Taipei (TW)

(72) Inventors: JUN-JIN PAN, Shenzhen (CN); PO-HSUN SHEN, New Taipei (TW); MIN DONG, Shenzhen (CN)

(73) Assignees: HON HAI PRECISION INDUSTRY CO., LTD., New Taipei (TW); HONG FU JIN PRECISION INDUSTRY (ShenZhen) CO.,LTD., Shenzhen (CN)

(21) Appl. No.: 13/893,341

(22) Filed: May 14, 2013

(30) Foreign Application Priority Data
Aug. 3, 2012 (CN) 2012102748179

(51) Int. Cl. G02B 6/38

(52) U.S. Cl. CPC G02B 6/381
USPC 385/78; 385/77

(57) ABSTRACT

An optical fiber connector is used for fastening a cable. The optical fiber connector includes a front housing, a fiber joining assembly, a fastening sleeve, and a rear housing. The front housing includes a base portion and a fixing portion extending from an end of the base portion. The fixing portion is applied for fastening the cable. The fastening sleeve is sleeved on the fixing portion of the front housing. The fiber joining assembly is received in the base portion of the front housing. The rear housing is sleeved on the fixing portion and is fastened to the base portion.

### BACKGROUND

1. Technical Field

The present disclosure relates to connectors, particularly to an optical fiber connector.

2. Description of Related Art

Optical fiber connectors mechanically couple and align the cores of fibers so that light can pass through. An LC connector is a small form factor fiber optic connector. The LC connector may comprise a front housing, a rear housing sleeved on the front housing, and a boot fastened to an end of the rearing housing away from the front housing. To cut down on a length of the LC connector, the length of the boot becomes shorter and shorter. As a result, the protective function of the boot on a cable received in the LC connector becomes weakened or inadequate.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the optical fiber connector. Moreover, in the drawings, like reference numerals designate corresponding parts throughout the several views. Wherever possible, the same reference numerals are used throughout the drawings to refer to the same or like elements of an embodiment.

FIG. 1 is an isometric, assembled view of an embodiment of an optical fiber connector.

FIG. 2 is an exploded, isometric view of the optical fiber connector of FIG. 1.

FIG. 3 is a cross-sectional view of the optical fiber connector of FIG. 1 taken along line III-III.

### DETAILED DESCRIPTION

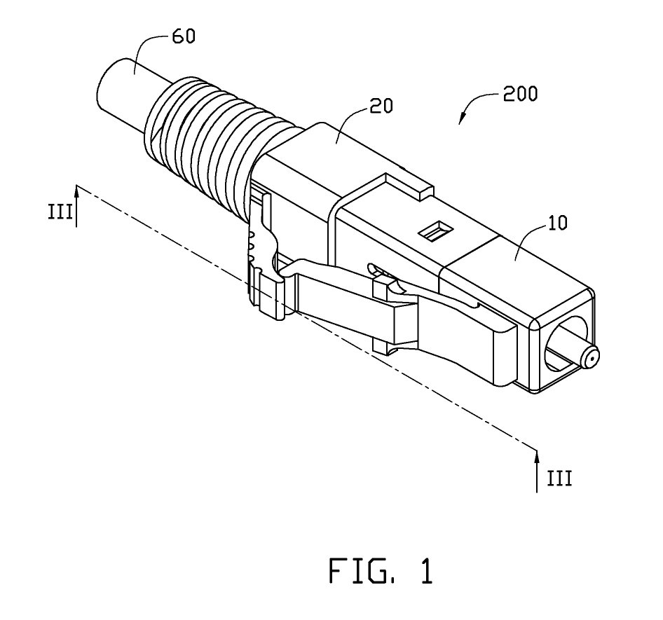

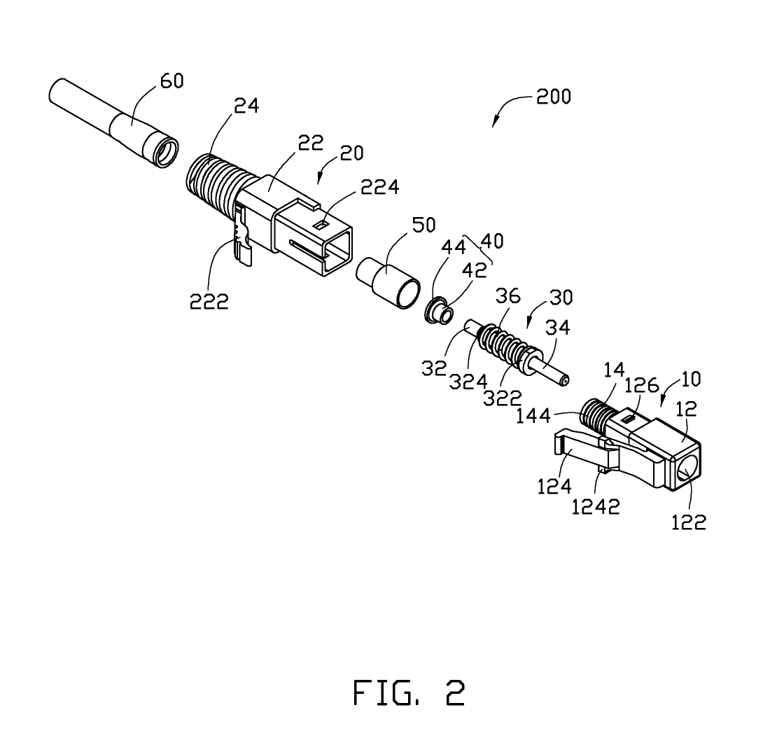

FIGS. 1 and 2 show an embodiment of an optical fiber connector 200 applied for fixing a cable (not shown). In the illustrated embodiment, the optical fiber connector 200 is an LC connector. The optical fiber connector 200 comprises a front housing 10, a rear housing 20, a fiber joining assembly 30, a supporting member 40, a fastening sleeve 50, and a boot 60. The rear housing 20 is sleeved on an end of the front housing 10. The boot 60 is sleeved in an end of the rear housing 20 away from the front housing 10.

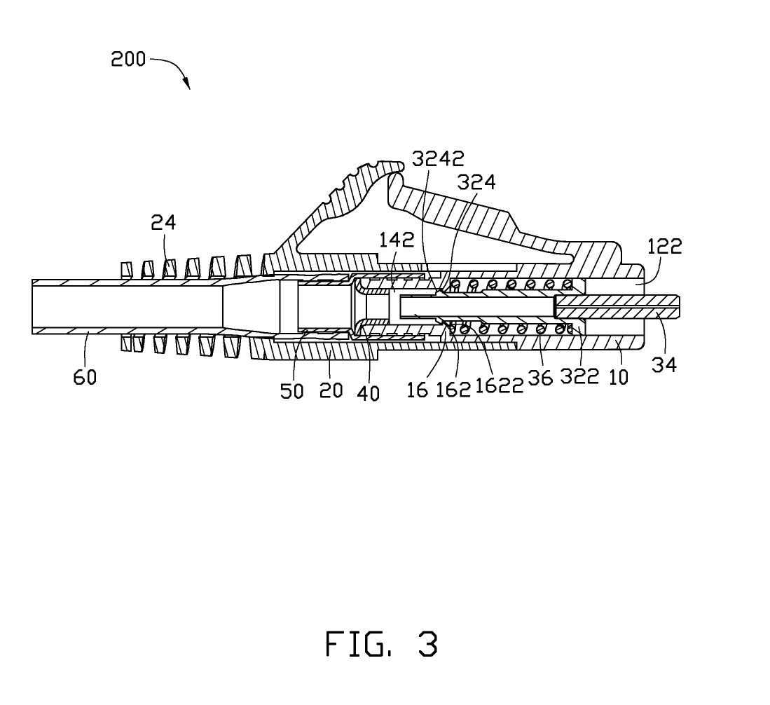

FIG. 3 shows that the front housing 10 which is integrally formed, is a substantially hollow cylinder, and is made of plastic material. The front housing 10 comprises a base portion 12 and a fixing portion 14 extending from an end of the base portion 12. The base portion 12 axially defines a receiving hole 122. In the illustrated embodiment, the transverse cross section of the base portion 12 is substantially rectangular. Four side walls of the base portion 12 cooperatively define the receiving hole 122 for receiving the fiber joining assembly 30. Two opposite inner sidewalls of the base portion 12 are substantially planar, and the other two opposite inner sidewalls of the base portion 12 are substantially arcuate. The front housing 10 further comprises a latching arm 124 formed at an outer surface of the base portion 12. In the illustrated embodiment, the latching arm 124 is elastic, and is capable of being bent towards the base portion 12. The latching arm 124 forms two protrusions 1242 opposite to each other and configured for engaging in a groove of an adapter (not shown). The base portion 12 forms two latching protrusions 126 extending out from the outer surface of the base portion 12. The two latching protrusions 126 are located at opposite sides of the latching arm 124, and are adjacent to the fixing portion 14.

The fixing portion 14 axially defines an inserting hole 142 communicating with the receiving hole 122, and forms a threaded portion 144 on the outer surface of the fixing portion 14. In the illustrated embodiment, a diameter of the inserting hole 142 is smaller than a diameter of the receiving hole 122. A resisting portion 16 (as shown in FIG. 3) is formed on the front housing 10 between the fixing portion 14 and the base portion 12. The resisting portion 16 forms a latching protrusion 162 radially extending towards the interior of the front housing 10. The latching portion 162 forms a chamfer 1622 adjacent to the receiving hole 122. In the illustrated embodiment, the chamfer 1622 is a conical surface. A diameter of the conical surface of the chamfer 1622 gradually decreases from the receiving hole 122 to the inserting hole 142, for facilitating the insertion of the fiber joining assembly 30 into the inserting hole 142.

The rear housing 20, is an integrally formed, substantially hollow cylinder, and is made of plastic material. The rear housing 20 comprises a main body 22 and an elastic portion 24 extending from an end of the main body 22. The main body 22 forms an elastic arm 222 extending from the outer surface of the main body 22 adjacent to the elastic portion 24. The main body 22 defines two latching holes 224 in the side surfaces of the main body 22 corresponding to the two latching protrusions 126 of the base portion 12. The two latching protrusions 126 are located at opposite sides of the elastic arm 222 and away from the elastic portion 24. The elastic portion 24 is a substantially hollow cylinder. In the illustrated embodiment, the elastic portion 24 is carved to be spiral to increase the elasticity of the elastic portion 24. When the cable is fastened in the optical fiber connector 200, the elastic portion 24 is sleeved on the cable to protect the optical fiber of the cable from being fractured or damaged. In alternative embodiments, the elastic portion 24 can be a reticular.

The fiber joining assembly 30 comprises a fixing member 32, an optical fiber ferrule 34 fixed to an end of the fixing member 32, and an elastic member 36 sleeved on the fixing member 32. The fixing member 32 is substantially cylindrical. The fixing member 32 comprises a shoulder 322 and a latching portion 324 extending from the outer surface of the fixing member 32. The shoulder 322 and the latching portion 324 are located at opposite ends of the fixing member 32. In the illustrated embodiment, the shoulder 322 is configured to be received in the receiving hole 122 of the front housing 10. The shoulder 322 comprises four outer surfaces (not labeled) corresponding to the four inner sidewalls of the front housing 10. Two opposite outer surfaces of the shoulder 322 are substantially planar, and the other two opposite outer surfaces thereof are substantially arcuate. When the shoulder 322 is received in the receiving hole 122 of the front housing 10, the shoulder 322 cannot be rotated. In an alternative embodiment, the shoulder 322 can have one or more than two rectangular outer surfaces, and the front housing 10 has the same number of the planar inner sidewalls, correspondingly.

The latching portion 324 forms a guiding surface 3242 at an end of the latching portion 324 away from the shoulder 322 for facilitating the insertion of the fixing member 32 into the inserting hole 142. In the illustrated embodiment, the guiding surface 3242 is a conical surface. A diameter of the conical surface of the guiding surface 3242 gradually decreases from one end of the conical surface adjacent to the shoulder 322 to the other end thereof. The elastic member 36 is a coil spring sleeved on the fixing portion 32.

In the illustrated embodiment, the supporting member 40 is made of magnesium alloy. In other embodiments, the supporting member 40 can be made of aluminum alloy, stainless steel, or other metallic materials. The supporting member 40 comprises a cylindrical portion 42 and a flange 44 formed at an end of the cylindrical portion 42. An outer diameter of the cylindrical portion 42 is substantially the same as a diameter of the inserting hole 142. The cylindrical portion 42 is capable of inserting into the inserting hole 142 for supporting the fixing portion 14. The cylindrical portion 42 is applied for enhancing the mechanical strength of the fixing portion 14. The flange 44 is applied for latching with the fixing portion 14 when the cylindrical portion 42 is inserted into the fixing portion 14. In alternative embodiments, the flange 44 can be omitted, or the supporting member 40 can be omitted.

The fastening sleeve 50 is made of plastic materials, and is sleeved on the threaded portion 144 of the fixing portion 14. In an alternative embodiment, the threaded portion 144 can be omitted.

The boot 60 is made of plastic materials, and is sleeved on an end of the fastening sleeve 50 away from the fixing portion 14 of the front housing 10. In an alternative embodiment, the fastening sleeve 50 can be omitted, and the boot 60 is sleeved on the fixing portion 14 of the front housing 10.

In assembly, the fiber joining assembly 30 is non-rotatably received in the receiving hole 122 of the front housing 10 with the latching portion 324 of the fixing member 32 latching with the latching protrusion 162 of the front housing 10. One end of the elastic member 36 resists against the shoulder 322 of the fixing member 32, and the other end of the elastic member 36 resists against the resisting portion 16 of the front housing 10. The cylindrical portion 42 of the supporting member 40 is inserted into the inserting hole 142 of the fixing portion 14. The fastening sleeve 50 is sleeved on the threaded portion 144 of the fixing portion 14. The boot 60 is sleeved on an end of the fastening sleeve 50 away from the fixing portion 14 of the front housing 10. The rear housing 20 is sleeved on the front housing 10 via the fixing portion 14 with the two latching protrusions 126 of the front housing 10 engaging with the two latching holes 224 of the rear housing 20 correspondingly.

Since the boot 60 is not required to be shortened, the protective function of the boot 60 on the cable received in the optical fiber connector 200 is not weaken, diminished or compromised, and an optical fiber of the cable received in the optical fiber connector 200 is not prone to be fractured. The fixing portion 14 is formed on an end of the front housing 10 and is received in the rear housing 20, which decreases a distance between the fixing portion 14 and the optical fiber ferrule 34, and the optical fiber connector 200 is shortened.

The present embodiments and their advantages will be understood from the foregoing description, and it will be apparent that various changes may be made thereto without departing from the spirit and scope of the embodiments or sacrificing all of its material advantages.

What is claimed is:

1. An optical fiber connector for fastening a cable, the optical fiber connector comprising:
a front housing comprising a base portion and a fixing portion, the fixing portion extending from an end of the base portion for fastening the cable;
a fastening sleeve sleeved on the fixing portion;
a fiber joining assembly received in base portion of the front housing; and
a rear housing sleeved on the fixing portion and fastened to the base portion of the front housing.

2. The optical fiber connector of claim 1, wherein the base portion axially defines a receiving hole, and the fiber joining assembly is non-rotatably received in the receiving hole.

3. The optical fiber connector of claim 2, wherein the fixing portion forms a threaded portion on an outer surface of the fixing portion, and the fastening sleeve is sleeved on the threaded portion of the fixing portion.

4. The optical fiber connector of claim 2, wherein the fixing portion axially defines an inserting hole communicating with the receiving hole, the optical fiber connector further comprises a supporting member received in the inserting hole for supporting the fixing portion.

5. The optical fiber connector of claim 4, wherein the supporting member comprises a cylindrical portion and a flange formed at an end of the cylindrical portion, and the cylindrical portion is received in the inserting hole of the fixing portion.

6. The optical fiber connector of claim 5, wherein an outer diameter of the cylindrical portion is substantially the same as a diameter of the inserting hole.

7. The optical fiber connector of claim 4, wherein the supporting member is made of magnesium alloy, aluminum alloy, or stainless steel.

8. The optical fiber connector of claim 4, wherein the fiber joining assembly comprises a fixing member, an optical fiber ferrule fixed in an end of the fixing member, and an elastic member sleeved on the fixing member.

9. The optical fiber connector of claim 8, wherein a resisting portion is formed on the front housing between the fixing portion and the base portion, the fixing member forms a shoulder at an end thereof adjacent to the optical fiber ferrule, one end of the elastic member resists against the shoulder of the fixing member, and the other end of the elastic member resists against the resisting portion of the front housing.

10. The optical fiber connector of claim 9, wherein the resisting portion forms a latching protrusion radially extending towards the interior of the front housing, and the latching portion forms a chamfer adjacent to the receiving hole.

11. The optical fiber connector of claim 10, wherein the chamfer is a conical surface, and a diameter of the conical surface of the chamfer gradually decreases from the receiving hole to the inserting hole for facilitating the insertion of the fiber joining assembly into the inserting hole.

12. The optical fiber connector of claim 1, wherein the rear housing is made of plastic material, and comprises a main body and an elastic portion extending from an end of the main body, and the main body is sleeved on the fixing portion of the front housing.

13. The optical fiber connector of claim 12, wherein the elastic portion is carved to be spiral to increase the elasticity of the elastic portion.

14. The optical fiber connector of claim 1, further comprising a boot sleeved on the fastening sleeve.

15. An optical fiber connector applied for fastening a cable, comprising:
a front housing comprising a base portion and a fixing portion, the fixing portion extending from an end of the base portion for fastening the cable;
a fiber joining assembly received in the base portion of the front housing; and
a rear housing sleeved on the fixing portion and fastened to the base portion.

16. The optical fiber connector of claim 15, wherein the base portion axially defines a receiving hole, and the fiber joining assembly is non-rotatably received in the receiving hole.

17. The optical fiber connector of claim 16, wherein the fixing portion forms a threaded portion on an outer surface of the fixing portion, and the fastening sleeve is sleeved on the threaded portion of the fixing portion.

18. The optical fiber connector of claim 16, wherein the fixing portion axially defines an inserting hole communicating with the receiving hole, the optical fiber connector further comprises a supporting member received in the inserting hole for supporting the fixing portion.

19. The optical fiber connector of claim 18, wherein the supporting member comprises a cylindrical portion and a flange formed at an end of the cylindrical portion, and the cylindrical portion is received in the inserting hole of the fixing portion.

20. The optical fiber connector of claim 19, wherein an outer diameter of the cylindrical portion is substantially the same as a diameter of the inserting hole.
